(19) United States
(12) Patent Application Publication
(10) Pub. No.: US 2007/0081420 A1
(43) Pub. Date: Apr. 12, 2007

(54) Static mixing device, discharge device and supply container comprising said mixing device, use of said mixing device and discharge method

(75) Inventors: Klaus Hempel, Friedersdorf (DE); Roland Erich Munkelt, Beiersdorf (DE)

Correspondence Address: SHOEMAKER AND MATTARE, LTD, 10 POST OFFICE ROAD - SUITE 110, SILVER SPRING, MD, 20910, US

(73) Assignee: EFTEC EUROPE HOLDING AG, SWITZERLAND (CH)

(21) Appl. No.: 10/578,196

(22) PCT Filed: Nov. 9, 2004
(86) PCT No.: PCT/EP04/12637

§ 371 Date: May 4, 2006

(30) Foreign Application Priority Data
Nov. 20, 2003 (EP) 0326474.1

(51) Int. Cl. B01F 5/06

(52) U.S. Cl. 366/340

(57) ABSTRACT

A static mixing device (1), containing at least one first mixing element (A) which contains a plurality of particularly parallel channels (2), which are orthogonal in relation to the main direction of flow (H), on a front side, wherein the channels (2) are not connected to each other but comprise through-flow openings (3) in the main direction of flow (H); further comprising a second mixing element (B) which enters into contact with the first mixing element (A) and which comprises a plurality of particularly parallel channels (2), which are orthogonal in relation to the main direction of flow (H), wherein the channels (2) are interconnected, wherein openings are more particularly provided in the side walls of the channels (2), enabling a medium (M) to pass therethrough in the main direction of flow (H). A plurality of more particularly parallel channels (2), which are not connected to each other, are arranged in an orthogonal manner in relation to the main direction of flow (H) on a rear side (R) thereof.

Static mixing devices and discharge devices, to be used with such static mixing devices, for especially viscous fluids have been known in many different forms for a long time.

The document EP-B1-0 495 169 discloses a static mixing device which is constructed from layered plates. In this case, fluid flows are conducted through the individual plate planes, the plates in each case having ducts connected to one another. Passage orifices on different planes of the plates are in each case arranged so as to be offset to one another.

A static mixer constructed from perforated plates is also known from U.S. Pat. No. 3,856,270. A further static mixer with serpentine-like liquid routing is shown in U.S. Pat. No. 4,222,671. In these two systems, the fluid flow is repeatedly broken up and recombined along the mixer. Static mixing devices of the type mentioned are often used together with discharge devices especially for two-component reactive mixtures, such as, for example, adhesives. Discharge devices of this type are known for single-component and multicomponent systems, for multicomponent systems both separate cartridges and combined supply containers, such as, for example, multichamber tubular bags, being used.

WO 01/44074, for example, discloses such a discharge device. Here, however, an adapter for the separate routing of the components between the supply container and the static mixer is provided, this being detrimental to the weight, overall height and handiness of the discharge device as a whole.

Further such or similar discharge devices are known, inter alia, from EP-A1-0 665 063, U.S. Pat. No. 3,323,682 and EP-B1-0 787 661.

The known static mixing devices have the disadvantage that, with a relatively low overall height, only inadequate intermixing is brought about. By contrast, known static mixing devices which achieve acceptable intermixing have such a great overall height that handiness, in particular together with a discharge device of the type initially mentioned, is impaired.

One object of the invention, therefore, is to avoid the disadvantages of the prior art, that is to say, in particular, to provide a static mixing device which can be produced in a simple way and as far as possible by known means, the overall height of which is as far as possible reduced and which, as far as possible, nevertheless has improved mixing properties. A further object of the invention is to provide a mixing device which is suitable for use with conventional discharge devices, such as are known, for example, for single-component and multicomponent systems, and to improve the handiness of such a system.

Said objects are achieved, according to the invention, by means of a static mixing device, a supply container, a discharge device and a method and a use according to the independent patent claims.

A static mixing device according to the invention contains at least one first mixing element which on a front side has a plurality of, in particular, parallel ducts transversely, in particular orthogonally, to the main flow direction, the ducts not being connected to one another, but having passage orifices in the main flow direction. By the ducts being arranged transversely to the main flow direction, a deflection or division of the flow is brought about. This takes place preferably by means of an orthogonal arrangement, but arrangements which are not rectangular are, of course, also possible. Moreover, at least one second mixing element which is in contact with the first mixing element is provided, which on a front side has a plurality of, in particular, parallel ducts transversely, in particular orthogonally, to the main flow direction, the ducts being connected to one another. Particularly in side walls of these ducts, orifices are provided, which allow the passage of a medium in the main flow direction. On a rear side of the second mixing element, a plurality of, in particular, parallel ducts, which are not connected to one another, are arranged orthogonally to the main flow direction. Other arrangements, in particular concentrically arranged arcuate ducts, are, of course, also possible, in addition to a parallel arrangement of the ducts, both in the first and in the second mixing element.

It was shown, surprisingly, that, by means of two mixing elements designed differently in this way, a substantially improved intermixing can be achieved, as compared with what is possible in the case of an identical number of mixing elements having other known mixing elements. The overall height of such a static mixing device can therefore be reduced, because fewer mixing elements have to be arranged for sufficient intermixing. Furthermore, the achievable final weight of such a device can also thereby be further reduced. Overall, the handiness of such a device is therefore simplified enormously, particularly in use with a discharge device, as also described below.

Here and hereafter, ducts of a mixing element which is in contact with a further mixing element are considered to be connected when an exchange of fluids between the respective ducts, in particular through their side walls, is possible. The main flow direction is understood here and hereafter to mean, in the case of straight static mixing devices, the direction along the longitudinal axis between the inlet and outlet of the medium. However, for example, curved mixing devices are, of course, also possible; in such a case, the main flow direction follows the curvature of the mixing device. The front side of a mixing element is understood here and hereafter to mean that side which faces the inlet for the substances to be mixed. A rear side of a mixing element is understood here and hereafter to mean that side which faces the outlet for the substances to be mixed.

In a particularly preferred embodiment, the first mixing element of the mixing device has the following features:
the passage orifices of adjacent ducts are arranged in each case in opposite halves of the front side of the mixing element;
no passage orifices are arranged in a middle region of all the ducts.

Moreover, the second mixing element has additionally or alternatively the following features:
on a front side, the ducts are connected to one another by means of a common connecting duct which is arranged in such a way that its position corresponds essentially to a rear-side region which is free of passage orifices;
in the region between a first side of the connecting duct and an outer edge of the second mixing element, passages are arranged which are not connected to the front-side ducts;
in the region between a second side of the connecting duct and an outer edge of the second mixing element, passage orifices are provided which are connected to the ducts.

It has been shown that a further improvement in intermixing can be achieved if only as a result of the abovementioned design of the first or second mixing element alone. Particularly preferred, however, is a simultaneous design of both mixing elements according to the above features, with the result that the mixing results achievable are further improved.

In a further preferred embodiment, the first and second mixing elements are arranged alternately. By virtue of such an alternating arrangement of the different mixing elements, the mixing action can be further improved. An alternating arrangement is in this case understood to mean, particularly preferably, arrangements in which no first (or second) mixing element is arranged directly adjacently to a further first (or second) mixing element. However, as variants of such an alternating arrangement, for example, arrangements alternating in groups are also possible, that is to say those arrangements in which a specific number of a first mixing element is followed by a number of second mixing elements.

In a further embodiment, the first and second mixing elements are designed as stackable plates. Plates of this type can be produced particularly simply and by known means, for example, by the plastic injection molding method. Stackability can in this case be brought about by the most diverse possible means, for example by regions of adjacent plates, in particular elevations and depressions, which are, in particular, specifically compatible with one another. In this case, it is particularly preferred that the plates are designed to be round on the outside, in particular with an identical outside diameter.

According to a particularly advantageous embodiment, the first and second mixing elements are stacked, rotated in relation to one another at a specific angle with respect to a comparable structural feature present on both mixing elements. Particularly preferably, the next mixing element in each case is in this instance arranged, rotated at this specific angle with respect to the preceding mixing element. At the same time, in particular, the direction of rotation in which the individual mixing elements are rotated does not change along the static mixing device. The achievable intermixing can thereby be further improved.

In a further particularly preferred embodiment, a second mixing element follows a first mixing element in the main flow direction, the ducts of this preceding first mixing element being arranged parallel to the rear-side ducts of the second mixing element. Moreover, a first mixing element follows a second mixing element in the main flow direction, the ducts of this following first mixing element being oriented, rotated at an angle of 90° in relation to the ducts on the rear side of the second mixing element.

It is particularly advantageous and preferred that the sequence of mixing elements contains paired arrangements of the first and second mixing elements, in each of the paired arrangements the ducts of the first mixing element being oriented parallel to the rear-side ducts of the second mixing element, but the ducts of a following paired arrangement being arranged, rotated in each case at an angle of 90° with respect to a preceding arrangement, in the main flow direction.

Furthermore, the mixing elements may have means for rotationally fixed stacking, in particular, at an angle of 90° or an even-numbered multiple of 90°. Particularly preferably, particularly in an edge region of the mixing elements, bosses are arranged, which are compatible with depressions of adjacent mixing elements in a stack of mixing elements. As a result, rotationally fixed stacking can be ensured in a simple way, along with the highest possible flexibility remaining in the set-up.

According to a further particularly advantageous embodiment of the invention, an entry piece is provided upstream of a first mixing element in the main flow direction and/or an end piece is provided downstream of a last mixing element in the main flow direction. By means of such an entry piece, an expansion of the components to be mixed, in particular pressed under pressure out of a supply container, can effectively be brought about, so that the flow impinges onto a first mixing element over a large area of the latter. Moreover, a preallocation of the fluid stream to the passage orifices of a first mixing element, which are arranged, in particular, on opposite sides of adjacent ducts, can be brought about. An end piece may preferably be employed for combining the fluid stream at an outlet orifice; further means, in particular baffles, which serve for intermixing may, of course, also be provided on such an end piece.

Advantageously, the mixing elements and, if appropriate, the entry piece and/or the end piece are arranged, in particular exchangeably, in a sleeve. As a result, both production can be simplified and, for special applications, the exchangeability of mixing elements can be obtained. It is further preferred that the sleeve is closed, in particular reversibly, by means of a connection piece for connection to a discharge device and/or is designed to be closable. This may involve, in particular, for example, screw and/or plug connections, but also clamping connections; screw connections are preferably used.

A mixing device of the type mentioned is advantageously employed for the mixing of at least two substances stored in a supply container having at least two compartments, the mixing device being arrangeable or arranged releasably or fixedly on the supply container or a discharge device. Supply containers of this type are intended, as a rule, for once-only use, that is to say cannot be refilled after being emptied, in particular where adhesives and sealants are concerned. Particularly for the applications mentioned, the static mixing devices are often likewise not multiply useable. Advantageously, therefore, supply containers of this type may even be produced and sold, in particular connected fixedly to such a static mixing device, thus making handiness for the final consumer even simpler due to a reduced requirement for manipulation.

A further aspect of the invention therefore relates to a supply container, in particular a multichamber tubular bag, having at least two compartments, a mixing device particularly of the type described above being connectable or connected releasably or fixedly to the supply container. Such a connection may be made, in particular, at the manufacturer's and irreversibly. It is also possible, however, in particular, to provide plug, screw and/or clamping connections. Moreover, with a view to the greatest possible reduction in overall height, it is advantageous to ensure an essentially direct connection between the outlet to the supply container and the static mixing device, that is to say as far as possible to dispense with adapters or the like.

An additional aspect of the invention relates, moreover, to a discharge device for the outlet of at least two substances to be mixed from either a combined supply container with at least two compartments or from a plurality of separate supply containers. These may be, in particular, parallel or coaxial double cartridge systems. Discharge devices of this type are obtainable on the market in the most diverse possible versions, in particular to be operated pneumatically or manually, for example from Mixpac (System 400) or PC Cox Ltd. (RBA 200B). In particular, multichamber tubular bag systems may also be used. The outlet of the supply container or supply containers is connectable or connected to a static mixing device. Discharge devices of this type are also sufficiently known, in particular, for single-component systems, for example MK Maskinsfabrik (TS 485 X). In the context of the present invention, it is particularly advantage that an essentially direct connection of the supply container to the static mixing device can be provided. The prior art, in particular WO 01/44074, presents problems of insufficient intermixing by means of static mixing devices, and, as a rule, these problems can be at least partially overcome by a separate routing of the components to be mixed, upstream of the actual mixing system. This results, however, in an undesirable prolongation of the operationally ready discharge device, this being detrimental to handiness. By means of a static mixing device according to the present invention, such a separate feed of the components to the mixing device is not necessary. An essentially direct connection can therefore be made between the outlet of a supply container and the static mixing device, without this having an adverse effect on the mixing result. The term “essentially direct” thus means, in this context, that there is technically no need for any distance between the supply container and static mixing device in order to achieve intermixing; this does not, however, rule out the possibility of a slight spacing, if appropriate, on account of the modular construction and/or possibly necessary sealing elements, etc.

The method according to the invention for the discharge of at least two substances to be mixed, in particular, from a supply container having at least two compartments, is thus distinguished in that the mixing of the substances takes place essentially solely by means of a static mixing device, in particular as outlined above. The term “essentially” means, here, that, if appropriate, further mixing may take place outside the static mixing device, but this is not of primary importance for the respective application. In this case, within the scope of the invention, in particular, additional applicator nozzles or the like may also be used, which, in addition to focusing the mixture to be applied, could, if appropriate, bring about further mixing.

The invention is explained in more detail below by means of exemplary embodiments and figures, without the subject of the invention being restricted to these. In the figures:

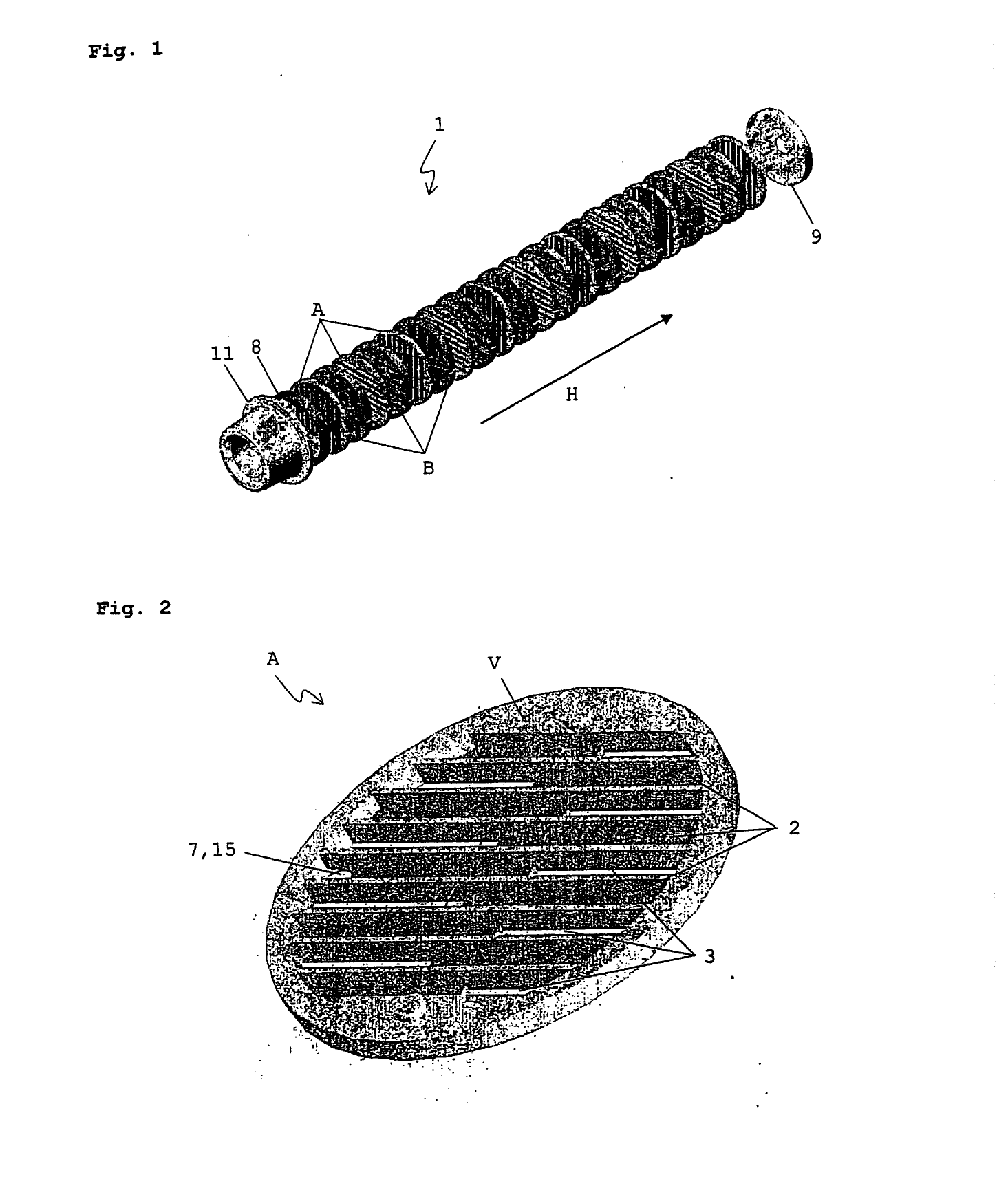

FIG. 1 shows an exploded illustration of a static mixing device;

FIG. 2 shows a first mixing element, front side;

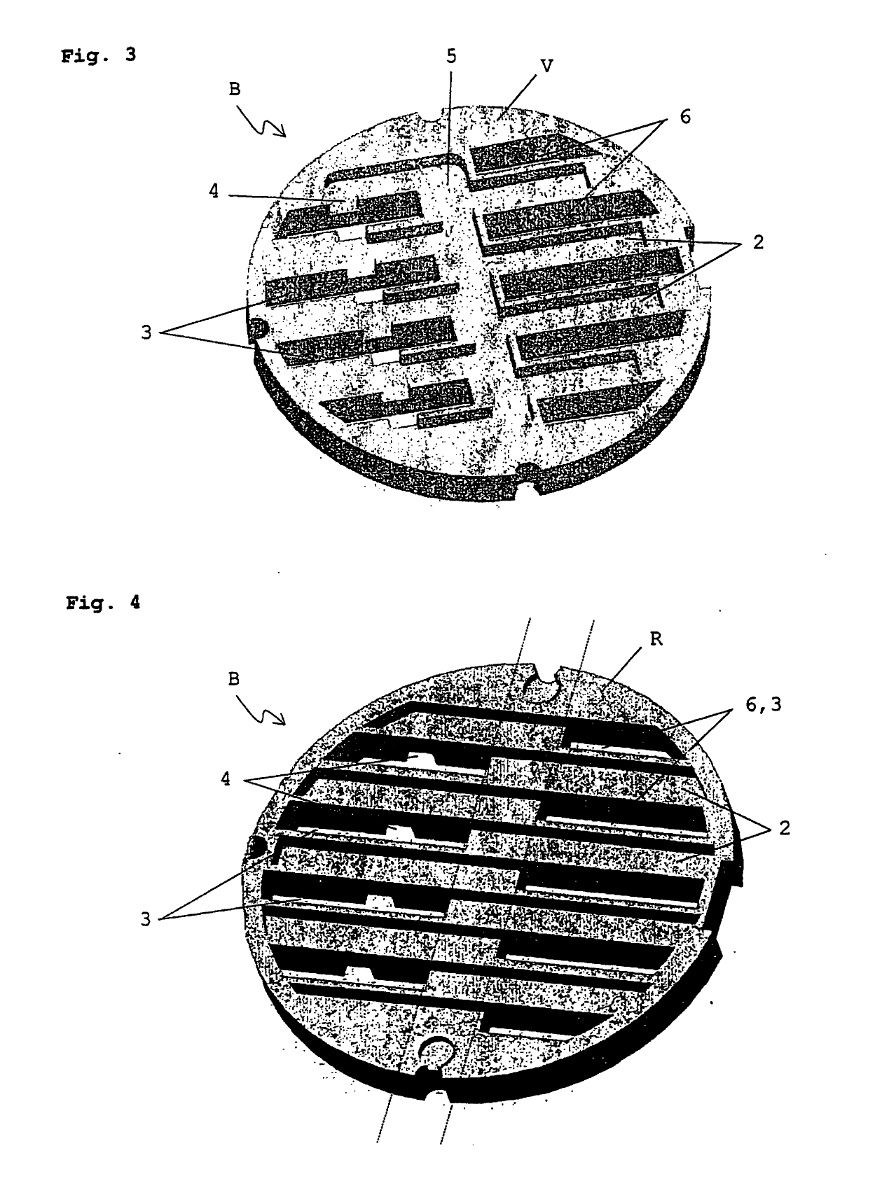

FIG. 3 shows a second mixing element, front side;

FIG. 4 shows a second mixing element, rear side;

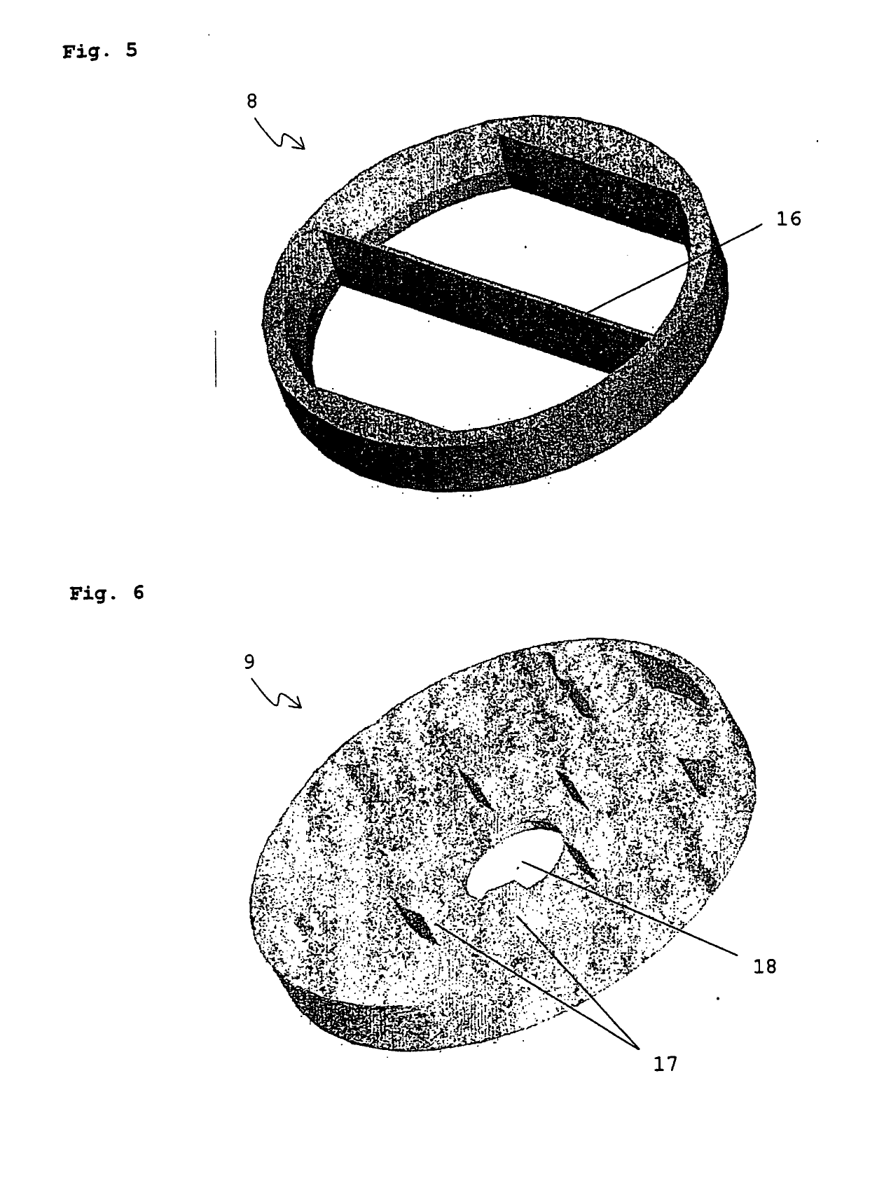

FIG. 5 shows an entry piece, front side;

FIG. 6 shows an end piece, front side;

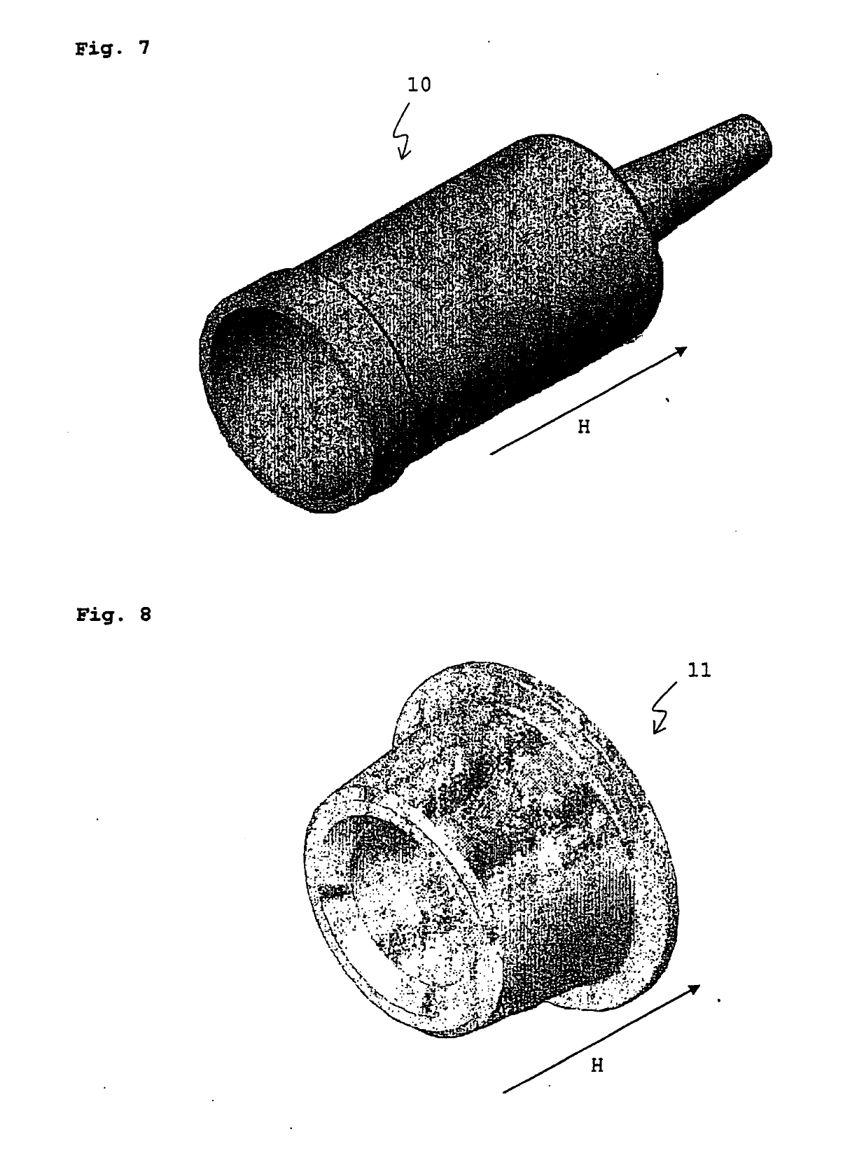

FIG. 7 shows a sleeve;

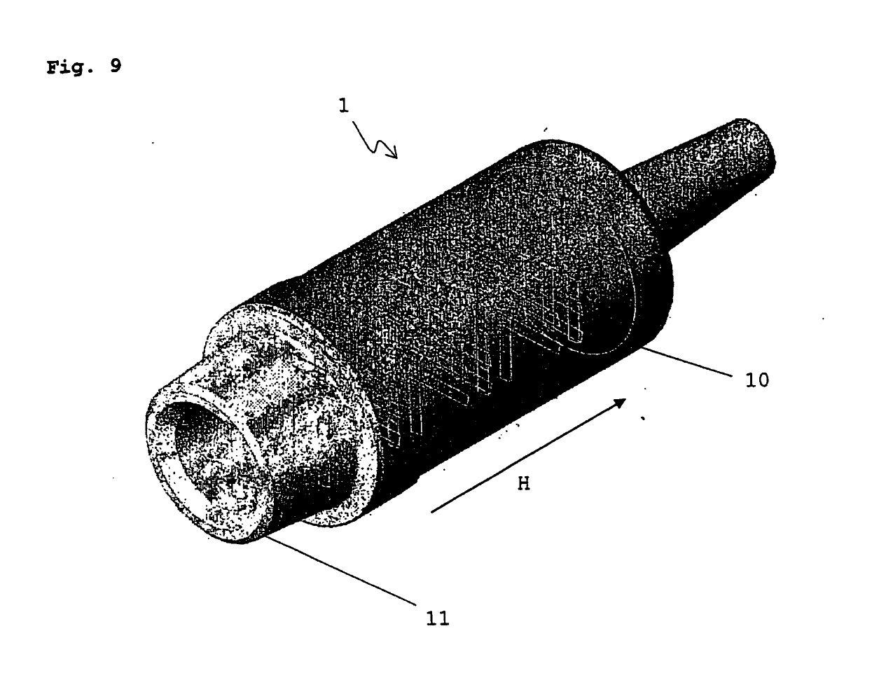

FIG. 8 shows a connection piece;

FIG. 9 shows a static mixing device, diagrammatically.

FIG. 1 shows an exploded illustration of a static mixing device 1 constructed from a plurality of first mixing elements A and second mixing elements B. The construction of the first and second mixing elements A, B is explained in detail below in FIGS. 2 and 3. The mixing elements A and B are designed as stackable plates. Moreover, the static mixing device 1 has a connection piece 11 (see also FIG. 8) and also an entry piece 8 and an end piece 9 (see also FIGS. 5 and 6). The connection piece 11 serves for connecting the static mixing device 1 to a, in particular, commercially available discharge device, not shown in detail. For example, plug, screw and/or clamping connections may be provided for the tie-up to such a discharge device. A plurality of, in particular two, in particular, flowable viscous substances to be mixed flow through the static mixing device 1 in the main flow direction H. For this purpose, as a rule, on account of the backpressure of the mixing elements, a working pressure of the order of magnitude of up to 6.0 to 6.5 bar must be applied in the main flow direction H. In the exemplary embodiment, the mixing elements A and B are arranged alternately in the main flow direction H as follows: A, B, A, B, etc. The individual mixing elements A, B are in this case arranged at an angle of rotation α increasing in the main flow direction H, specifically, in each case, every next mixing element A or B at an additional 90° with respect to the position of the preceding mixing element A or B.

FIG. 2 shows a first mixing element A from a front side V in detail. The mixing element A has a plurality of parallel ducts 2 which are not connected to one another. The individual ducts have in each case passage orifices 3 to the rear side of the mixing element A. The passage orifices 3 of adjacent ducts 2 are located on opposite sides of the mixing element A. In this case, a middle region of all the ducts 2 is free of any passage orifices. There are no ducts 2 located on the rear side, not shown in detail, of the mixing element A. Moreover, the mixing element 2 has means for the rotationally fixed stacking of mixing elements A, B. These are preferably bosses and clearances compatible with these bosses. The bosses and clearances are in this case arranged on opposite sides of the mixing element A in such a way that stacking at an angle of rotation α of 90° or a multiple of 90° is made possible.

FIG. 3 shows the front side V of a mixing element B. The mixing element B has a plurality of ducts 2 which are connected to one another by means of a connecting duct 5. On the far side of a first side of this connecting duct 5, on the right of the connecting duct 5 in the figure, the ducts 2 have no passage orifices. On this side, however, there are passages 6 which are not connected to the ducts 2. On the far side of a second side of this connecting duct, on the left of the connecting duct 5 in the figure, the ducts have in each case at least one orifice 4 in a side wall, with the result that the ducts 2 are connected to passage orifices 3.

FIG. 4 shows the rear side R of a mixing element B according to FIG. 3. In the exemplary embodiment, this rear side R is configured as far as possible similarly to the front side of a mixing element A: the rear side R of the mixing element B has a plurality of ducts 2 which are not connected to one another. In a middle region of all the ducts 2, the region between the dashed lines in the figure, there are no passage orifices 3. In a region located on the right of this middle region in the figure, the ducts 2 have passage orifices 3; these are designated as passages 6 in FIG. 3. These, therefore, as passages 6, are not connected to the front-side ducts 2 on the front side V of the mixing element B (see FIG. 3), whereas, on the rear side R, they are connected as passage orifices 3 to the rear-side ducts 2. In a region located on the left of the middle region in the figure, the ducts 2 likewise have passage orifices 3 which are connected to the front-side ducts 2 via the orifices 4. The passage orifices 3 of adjacent ducts 2 on the rear side R of the mixing element B are arranged on opposite sides of the mixing element B.

FIG. 5 shows an entry piece 8 which precedes a first mixing element in the main flow direction H. This entry piece has particularly advantageously a middle web 16 which is arranged in the middle region of the ducts 2 of the first mixing element A in the main flow direction H. By means of such an entry piece 8, a preallocation of the fluid stream to the passage orifices 3 of a first mixing element A or B which are arranged on opposite sides of adjacent ducts 2 can be brought about.

FIG. 6 shows an end piece 6 which is arranged downstream of a last mixing element B in the main flow direction H. In such an end piece 6, the fluid stream is combined again at an outlet orifice 18. Moreover, the end piece 6 has baffles 17 which are arranged preferably concentrically about the outlet orifice 17 and likewise serve for the intermixing.

FIG. 7 shows a sleeve 10 for the reception of a plurality of mixing elements A and B, of the entry piece 8 and of the end piece 9. The sleeve is subsequently closed by means of a connection piece 11 shown in FIG. 8. This may be both a releasable connection of the sleeve 10 and connection piece 11 and an irreversible connection. FIG. 9 shows a ready-to-use mixing device which can be connected, in particular, to commercially available discharge devices via the connection piece 11. Located within the sleeve 10 is the static mixing device, indicated merely diagrammatically in the drawing, which is constructed from a plurality of mixing elements A, B. Preferred materials for the mixing elements A, B, the entry piece and the end piece and also the sleeve 10 are, in particular, polypropylene (PP), polyethylene (PE) and polyamides which, if appropriate, may be reinforced with glass fibers. However, other materials, in particular plastics or even metals, may, of course, also be selected for the respective application; materials of this type and their specific benefits are known to a person skilled in the art.

Comparative tests of a static mixing device 1 according to the invention, in each case with 11 mixing elements A and B according to the arrangement shown in FIG. 1, with a Mixpac standard mixer from Statomix (inside diameter 10 mm, length 217 mm) were conducted. In this case, the components of the two-component adhesive Dinitrol 512 2K HM were mixed via the static mixing devices, and the achievable adhesive properties were compared with one another in terms of the combined tension and shear resistances measured at various time points. In these comparative tests, glass was bonded to lacquered sheet metal, both substrates having been pretreated with glass primer and lacquer primer respectively. Such pretreatments are in accordance with the current practice of a person skilled in the art. The components were in this case pressed through the static mixing devices at a pressure of 6 bar. The following results were in this case obtained (Table 1):

TABLE 1
Comparative tests

| Combined tension | Static mixing device | “Mixpac” static |
|---|---|---|
| and shear resistance | according to FIG. 1 | mixing device |
| after ½ h | 0.18 MPa | 0.13 MPa |
| after 1 h | 0.31 MPa | 0.3 MPa |
| after 24 h | 5.9 MPa | 7.0 MPa |

It is clear from the combined tension and shear resistances determined that, both a short time after bonding and in terms of ultimate resistance, adhesive results can be achieved which are comparable in the mixing of the components via a mixing device according to the invention with a mixing of the components via the Mixpac mixing device. From the combined tension and shear resistances obtained in the resulting bonding, an achieved intermixing of the components which satisfies all requirements can be concluded. In comparison with the Mixpac reference mixer, however, the mixer according to the invention is considerably more compact, with a length of only 130 mm (even including the connection piece 11 and sleeve 10 with outlet nipple) and a width of 41.5 mm. For comparison: the Mixpac standard mixer from Statomix has a length of 217 mm (see above).

1-16. (canceled)

17. A static mixing device (1), containing
at least one first mixing element (A) which on a front side (V) has a plurality of ducts (2) transversely to a main flow direction (H), the ducts (2) not being connected to one another, but having passage orifices (3) in the main flow direction (H); and
at least one second mixing element (B) which is in contact with the first mixing element (A) and which has on a front side (V) a plurality of ducts (2) transversely to the main flow direction (H), the ducts (2) being connected to one another; in the ducts (2) orifices (4) being provided which allow the passage of a medium in the main flow direction (H) from the ducts (2) of the front side (V) to the rear side (R) of the second mixing element (B); and, on a rear side (R) of the second mixing element (B), a plurality of ducts (2), which are not connected to one another, being arranged orthogonally to the main flow direction (H),
the ducts (2) of the first mixing element (A) and of the second mixing element (B) being arranged in such a way that a passage of a medium through the mixing elements (A, B) is made possible.

18. The mixing device (1) as claimed in claim 17, characterized in that the first mixing element (A) has the following features:
the passage orifices (3) of adjacent ducts (2) are arranged in each case in opposite halves of the front side of the mixing element (A);
no passage orifices (3) are arranged in a middle region of all the ducts (2);
and/or the second mixing element (B) has the following features:
on a front side (V), the ducts (2) are connected to one another by means of a common connecting duct (5) which is arranged in such a way that its position corresponds essentially to a rear-side region which is free of passage orifices (3);
in the region between a first side of the connecting duct and an outer edge of the second mixing element, passages are arranged which are not connected to the front-side ducts;
in the region between a second side of the connecting duct and an outer edge of the second mixing element, passage orifices are provided which are connected to the ducts.

19. The mixing device (1) as claimed in claim 17, the first and second mixing elements (A, B) being arranged alternately.

20. The mixing device (1) as claimed in claim 17, the first and second mixing elements (A, B) being designed as stackable plates.

21. The mixing device (1) as claimed in claim 19, characterized in that the first and second mixing elements (A, B) are stacked, rotated in relation to one another at an angle (a) with respect to parallel ducts (2).

22. The mixing device (1) as claimed in claim 19, characterized in that
a second mixing element (B) follows a first mixing element (A) in the main flow direction (H), the ducts (2) of this preceding first mixing element (A) being arranged parallel to the rear-side ducts (2) of the second mixing element (B);
and in that
a first mixing element (A) follows a second mixing element (B) in the main flow direction (H), the ducts (2) of this following first mixing element (A) being oriented at an angle (a) of 90° with respect to the rear-side ducts (2) of the second mixing element (B).

23. The mixing device (1) as claimed in claim 19, characterized in that the sequence of the first and second mixing elements (A, B) contains paired arrangements (x, x+1, x+2, . . . x+n) of the first and second mixing elements (A, B), in each of the paired arrangements (x, x+1, x+2, . . . , x+n) the ducts (2) of the first mixing element (A) being oriented parallel to the rear-side ducts (2) of the second mixing element (B), but the ducts of a following paired arrangement (x+1) being arranged, rotated in each case at an angle (a) of 90° with respect to a preceding arrangement (x), in the main flow direction (H).

24. The mixing device (1) as claimed in claim 17, characterized in that the mixing elements (A, B) have means, in particular bosses and clearances, for rotationally fixed stacking, in particular, at an angle (a) of 90° or an even-numbered multiple of 90°.

25. The mixing device (1) as claimed in claim 17, characterized in that an entry piece (8) is provided upstream of a first mixing element (A, B) in the main flow direction (H), and an end piece (9) is provided downstream of a last mixing element (A, B) in the main flow direction (H).

26. The mixing device (1) as claimed in claim 17, characterized in that the mixing elements (A, B) are arranged in a sleeve (10).

27. The mixing device (1) as claimed in claim 26, characterized in that the sleeve (10) is closed by means of a connection piece (11) for connection to a discharge device and/or is designed to be closable.

28. A supply container, in particular a multichamber tubular bag, having at least two compartments, characterized in that a mixing device (1) as claimed in claim 17 is connectable or connected releasably or fixedly to the supply container.

29. A discharge device for the outlet of at least two substances to be mixed from a supply container having at least two compartments, characterized in that an outlet of the supply container is connectable or connected essentially directly to a static mixing device (1) as claimed in claim 17.

30. A method for the discharge of at least two substances to be mixed from a supply container, characterized in that the mixing of the substances takes place essentially by means of a static mixing device (1) as claimed in claim 17.
